(19) United States
(12) Patent Application Publication
(10) Pub. No.: US 2012/0146804 A1
(43) Pub. Date: Jun. 14, 2012

(54) METHOD AND DEVICE FOR LIGHT INDICATION

(75) Inventors: Insu Kim, Seoul (KR); Tae-Gyu Kang, Daejeon (KR); Seong Hee Park, Daejeon (KR)

(73) Assignee: Electronics and Telecommunications Research Institute, Daejeon (KR)

(21) Appl. No.: 13/289,407

(22) Filed: Nov. 4, 2011

(30) Foreign Application Priority Data
Dec. 9, 2010 (KR) 10-2010-0125821

(51) Int. Cl. G08B 5/00

(52) U.S. Cl. 340/691.1

(57) ABSTRACT

A lighting indication device is connected to a plurality of LED sensing lightings via a lighting network. A receiver receives sensing information from at least one of the plurality of LED sensing lightings via the lighting network, and determines whether the sensing information includes a warning code. A warning position identifier identifies a position of an LED sensing lighting in which warning occurs based on the sensing information when the sensing information includes the warning code. A path setting unit generates a warning lighting signal for indicating warning generation information and an escape guide lighting signal indicating an escape guide direction based on the position of the LED sensing lighting in which the warning occurs. A transmitter transmits the warning lighting signal and the escape guide lighting signal to the plurality of LED sensing lightings via the lighting network.

### CROSS-REFERENCE TO RELATED APPLICATION

This application claims priority to and the benefit of Korean Patent Application No. 10-2010-0125821 filed in the Korean Intellectual Property Office on Dec. 9, 2010, the entire contents of which are incorporated herein by reference.

### BACKGROUND

(a) Field

The present invention relates to a method and device for lighting indication.

(b) Description of the Related Art

As a lighting device widely uses LEDs, which are semiconductor elements that can transmit information using visible light, as light sources, technology for controlling the lighting device via a network has been developed. Further, a sensing-based warning system that can perform an additional function as well as a lighting function by attaching a light sensor or a heat sensor is researched.

A service recognizing an emergency can be provided by coupling a sensor for providing a specific warning service and a lighting device. However, this technology restricts a merit of a network-based LED lighting system that includes a set of multi-light sources and can perform individual control and high speed modulation. Further, it is difficult to apply this technology to new various application services.

As the related art, there is a fire warning and lighting system that performs both a lighting function and a fire warning function. The fire warning and lighting system drives a lighting lamp or siren or notifies a designated institution of a fire warning situation by executing a fire warning mode when detecting fire by a fire detection sensor installed on the lighting lamp. However, in the warning lighting system, warning devices do not organically cooperate with guide lightings, and a visual service cannot be provided to a user on a position where lighting devices are not easily recognized.

### SUMMARY

Embodiments of the present invention provide a method and device for lighting indication for providing a warning function and a guide function with directionality using lightings when a warning occurs.

An embodiment of the present invention provides a lighting indication device connected to a plurality of LED sensing lightings via a lighting network. The lighting indication device includes a receiver, a warning position identifier, a path setting unit, and a transmitter. The receiver receives sensing information from at least one of the plurality of LED sensing lightings via the lighting network, and determines whether the sensing information includes a warning code. The warning position identifier identifies a position of an LED sensing lighting in which warning occurs based on the sensing information when the sensing information includes the warning code. The path setting unit generates a warning lighting signal for indicating warning generation information and an escape guide lighting signal for indicating an escape guide direction based on the position of the LED sensing lighting in which the warning occurs. The transmitter transmits the warning lighting signal and the escape guide lighting signal to the plurality of LED sensing lightings via the lighting network.

Each LED sensing lighting may include a sensor configured to generate the sensing information and LED lighting configured to flicker according to the warning lighting signal and the escape guide lighting signal.

The receiver may extract an identifier of a sensor in which the warning occurs from the sensing information, and the path setting unit may determine a position of the sensor in which the warning occurs based on the identifier.

The lighting indication device may further include a lighting distribution storage configured to store lighting distribution information about a distribution state of the plurality of LED sensing lightings.

The path setting unit may search for the path generating information and the escape guide path based on the position of the sensor and the lighting distribution information of the lighting distribution storage.

The warning lighting signal may include the lighting distribution information.

The warning lighting signal and the escape guide lighting signal each may include information for controlling a flickering speed of the LED lighting.

The warning lighting signal and the escape guide lighting signal each may include information for controlling a flickering color of the LED lighting.

The warning generation information may include a direction where the warning occurs. The warning generation information may further include a position where the warning occurs.

The lighting indication device may further include an outside warning receiver configured to receive warning data from an outside path.

Another embodiment of the present invention provides a method of indicating lighting of a lighting indication device connected to a plurality of LED sensing lightings via a lighting network. The method include receiving sensing information, identifying a warning generation position based on the sensing information when the sensing information includes a warning code, generating a warning lighting signal for indicating warning generation information and an escape guide lighting signal for indicating an escape guide direction based on the warning generation position, and transmitting the warning lighting signal and the escape guide lighting signal to the plurality of LED sensing lightings via the lighting network.

The warning generation information may include a warning generation direction.

When receiving the sensing information, the sensing information that is detected in at least one of the plurality of LED sensing lightings may be received.

When identifying the warning generation position, the warning generation position may be identified based on an identifier of the at least one LED sensing lighting.

The method may further include generating the warning generation information and the escape guide direction based on the warning generation position and a database that stores lighting distribution information about a distribution state of the plurality of LED sensing lightings.

The warning lighting signal and the escape guide lighting signal each may include information for controlling at least one of a flickering speed and a flickering color of the LED sensing lighting.

Yet another embodiment of the present invention provides a method of processing warning in a visible light receiving terminal connected to a plurality of LED sensing lightings via visible light communication. The method includes receiving a visible light communication signal from at least one of the plurality of LED sensing lightings, extracting a warning code from the visible light communication signal, determining whether an outside contact is necessary based on the warning code, displaying, a warning generation position based on the visible light communication signal when the outside contact is terminated or is unnecessary, and displaying an escape path.

The visible light communication signal may include lighting distribution information of the plurality of LED sensing lightings

When displaying the warning generation position, the warning generation position may be displayed based on the lighting distribution information.

The method may further include searching for a phone number for the outside contact based on the warning code when the outside contact is necessary.

### BRIEF DESCRIPTION OF THE DRAWINGS

FIG. 1 is a diagram showing a lighting indication system according to an embodiment of the present invention.

FIG. 2 is a block diagram showing LED sensing lighting of FIG. 1.

FIG. 3 is a diagram showing a structure of LED lighting of LED sensing lighting of FIG. 1.

FIG. 4 is a block diagram showing a lighting indication device of FIG. 1.

FIG. 5 is a flowchart showing a method of performing lighting indication in a lighting indication device according to an embodiment of the present invention.

FIG. 6 is a flowchart showing a method of processing warning in a visible light receiving terminal according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

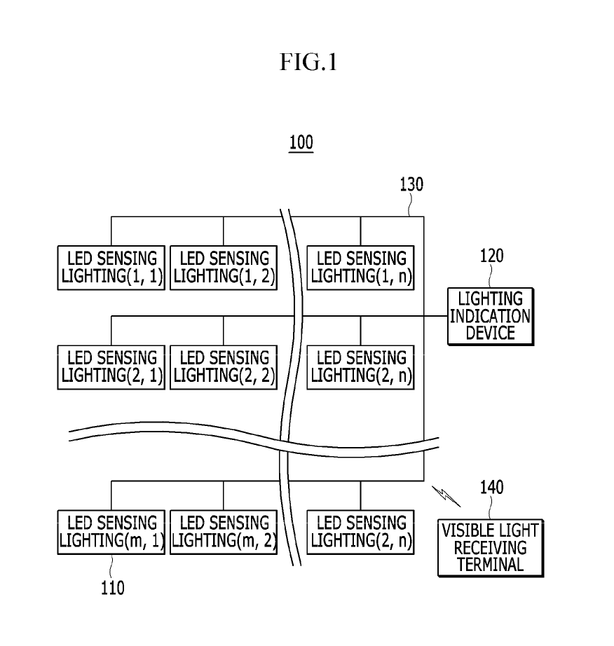

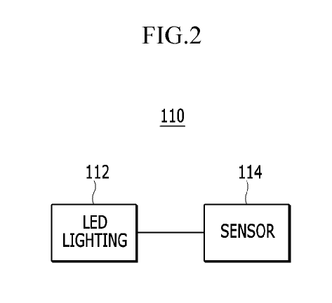

FIG. 1 is a diagram showing a lighting indication system according to an embodiment of the present invention, and FIG. 2 is a block diagram showing LED sensing lighting of FIG. 1.

Referring to FIG. 1, the lighting indication system includes a plurality of LED sensing lightings 110, a lighting indication device 120, an LED lighting network 130 that connects them, and a visible light receiving terminal 140.

Referring to FIG. 2, the LED sensing lighting 110 includes an LED lighting 112 and a sensor 114 and has an identifier (ID) for individual control. The sensor 114 transmits a warning code corresponding to its type, and the LED lighting 112 transmits visible light including an indoor position and path information.

Referring again to FIG. 1, the lighting indication device 120 dynamically transfers a warning generation direction and an escape guide direction by sequentially blinking the LED sensing lightings 110 and transmits additional information using visible light communication. When the LED sensing lightings 110 are arranged in an approximately m×n matrix form, the lighting indication device 120 may blink the LED sensing lightings 110 in order of (m, 1), (m, 2), (m, 3), . . . , (m, n) or in reverse order thereof, or in order of (1, n), (2, n), (3, n), . . . , (m, n) or in reverse order thereof.

The LED lighting network 130 connects the LED sensing lightings 110 and the lighting indication device 120, may have a topology such as a bus, a ring, a tree, or a star, and has a bi-directional communication function. The LED lighting network 130 transfers sensing data generated in the LED sensing lightings 110 to the lighting indication device 120, and transfers lighting control data from the lighting indication device 120 to each LED sensing lighting 110. Further, the LED lighting network 130 transmits the additional information from the lighting indication device 120 to the LED sensing lightings 110 using the visible light communication.

The visible light receiving terminal 140 receives a visible light communication signal including path data from the LED sensing lightings 110 and displays a warning generation position and/or an escape path to a user. The visible light receiving terminal 140 may be used for reporting a present situation to the outside by the control of the user.

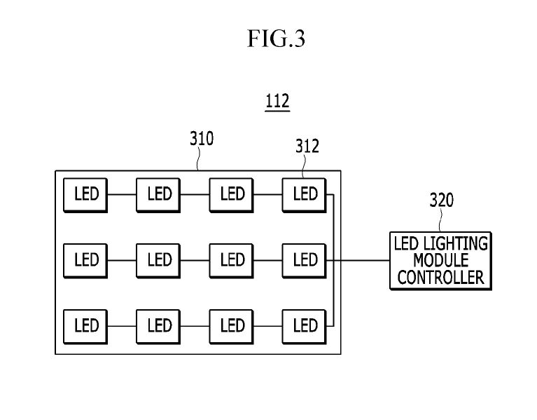

FIG. 3 is a diagram showing a structure of an LED lighting 112 of the LED sensing lightings 110 of FIG. 1.

Referring to FIG. 3, the LED lighting 112 includes an LED module 310 and an LED lighting module controller 320.

The LED module 310 includes a plurality of LED light sources 312 that can be controlled individually or collectively. The LED lighting module controller 320 blinks the LED module 310 with lighting control data received from the LED lighting network 130.

The plurality of LED light sources 312 may emit light of a single color or multi-colors, and performs a warning direction indication and/or an escape guide direction indication with the color of the light. The LED lighting module controller 320 has a communication interface that can be connected to the LED lighting network 130. The LED lighting module controller 320 controls each of the LED light sources 312 of the LED module 310 by a point unit, a horizontal line unit, or a vertical line unit, and displays visible lighting with directionality by controlling a flickering order of the LED light source 312. Further, the LED lighting module controller 320 transmits the additional information to the visible light receiving terminal 140 by blinking the LED light sources 312 in a high speed.

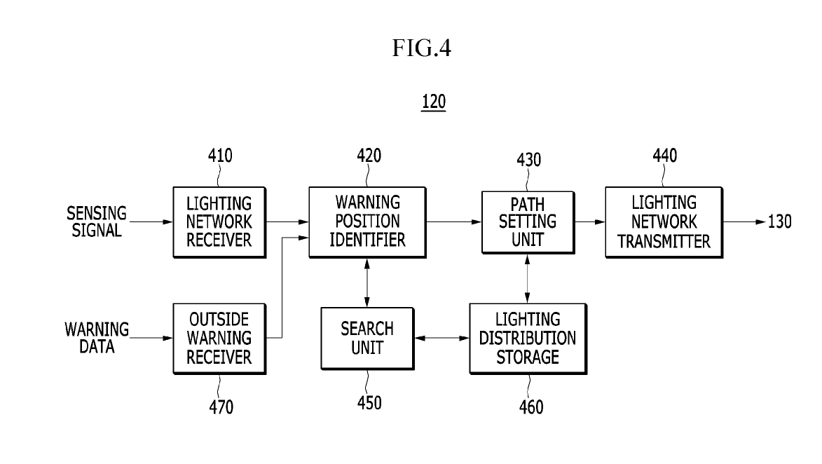

FIG. 4 is a block diagram showing the lighting indication device 120 of FIG. 1.

Referring to FIG. 4, the lighting indication device 120 includes a lighting network receiver 410, a warning position identifier 420, a path setting unit 430, a lighting network transmitter 440, a search unit 450, a lighting distribution storage 460, and an outside warning receiver 470.

The lighting network receiver 410 receives a sensing signal that is generated in the sensor 114 of the LED sensing lighting 110 via the LED lighting network 130. The lighting network receiver 410 analyzes the sensing signal, and transfers a warning code and an ID of the sensor 114 to the warning position identifier 420 when the analyzed sensing signal includes the warning code.

The warning position identifier 420 transfers a sensor ID that is transferred by the lighting network receiver 410 to the search unit 450. The search unit 450 searches for a position of a sensor corresponding to the sensor ID from positions of sensors that are stored at the lighting distribution storage 460. The warning position identifier 420 determines the position of the sensor that is searched in the search unit 450, and transfers the sensor position to the path setting unit 430.

The path setting unit 430 generates a warning lighting signal that can indicate warning generation information based on the position of the warning generating sensor received from the warning position identifier 420. The warning generation information includes a warning generating point and/or a warning generation direction. Further, the path setting unit 430 further generates an escape guide lighting signal for indicating a dynamic escape guide direction that can guide to a shelter by escaping the position of the warning generating sensor. In this case, the path setting unit 430 may search for lighting distribution information of a region corresponding to the position of the warning generating sensor in the lighting distribution storage 460, and add the lighting distribution information to the lighting warning signal.

The lighting distribution storage 460 stores lighting distribution information in which a distribution state of the LED lighting 112 is structuralized in a database using an ID of the LED lighting 112 as an index. In this case, the distribution state of the LED lighting 112 may be manually structuralized by a manager or actively structuralized by communication technology.

The lighting network transmitter 440 transmits the warning lighting signal and an escape guide lighting signal that are generated in the path setting unit 430 to the LED lighting control network 130. In this case, the warning lighting signal and the escape guide lighting signal each includes a warning code and path data.

The outside warning receiver 470 receives warning data generated in a path besides the LED lighting network 130, for example an emergency switch or the other lighting network, and transfers the warning data to the warning position identifier 420.

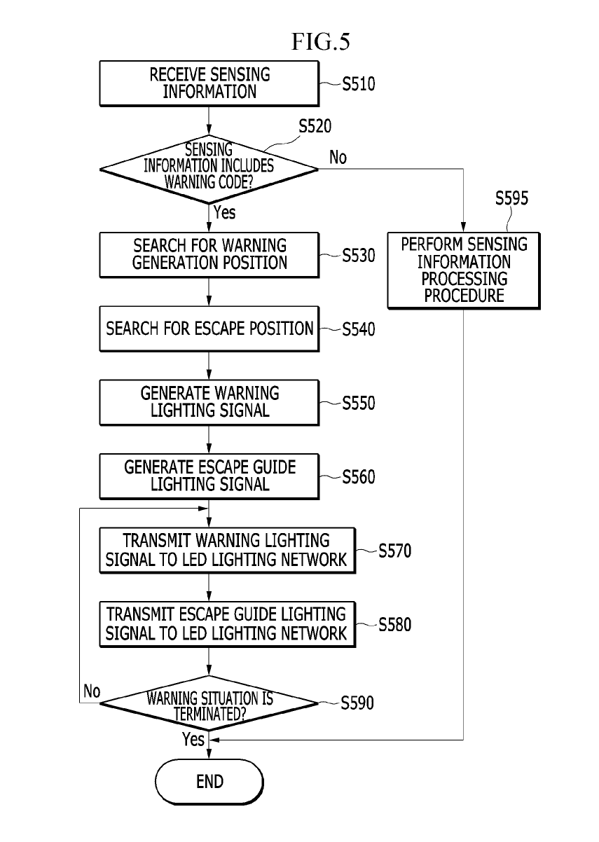

FIG. 5 is a flowchart showing a method of indicating lighting in the lighting indication device 120 according to an embodiment of the present invention.

Referring to FIG. 5, the lighting indication device 120 receives sensing information from the LED lighting network 130 or the outside (S510). The lighting indication device 120 determines whether sensing information includes a warning code (S520), and performs a general sensing information processing procedure when the sensing information does not include the warning code (S595).

If the sensing information includes the warning code, the lighting indication device 120 searches for a warning generation position based on the sensing information (S530), and searches for an escape position that can escape from the warning generation position (S540). The lighting indication device 120 generates a warning lighting signal for allowing the LED lightings 112 to indicate a position and/or a direction in which the warning occurs with reference to the lighting distribution storage 460 (S550). Further, the lighting indication device 120 computes a guide lighting path that can guide to the escape position by escaping the warning generation position with reference to the lighting distribution storage 460, and generates an escape guide lighting signal for allowing the LED lightings 112 to indicate the guide lighting path (S560).

The lighting indication device 120 transmits the warning lighting signal to the LED lighting network 130 to transfer the warning lighting signal to the LED lightings 112 connected to the LED lighting network 130 (S570). The LED lightings 112 which are received the warning lighting signal indicate the warning generation position through flickering of the LED light sources based on the warning lighting signal. In this case, the warning lighting signal may further include a warning code, lighting distribution information, and an audible warning signal to be transmitted using visible light communication. The lighting indication device 120 transmits an escape guide lighting signal representing a safe escape path to the LED lighting network 130 to transfer the escape guide lighting signal to the LED lightings 112 connected to the LED lighting network 130 (S580). The LED lightings 112 which are received the escape guide lighting signal indicate an escape guide direction through flickering of the LED light sources. The lighting indication device 120 repeats the steps of S570 and S580 until a warning situation is terminated (S590).

When the LED lightings 112 are single color lightings, the warning lighting signal, the escape guide lighting signal, or the warning code may be indicated by controlling a flickering speed. When the LED lightings 112 are multi-color lightings, the warning lighting signal, the escape guide lighting signal, or the warning code may be indicated by representing colors.

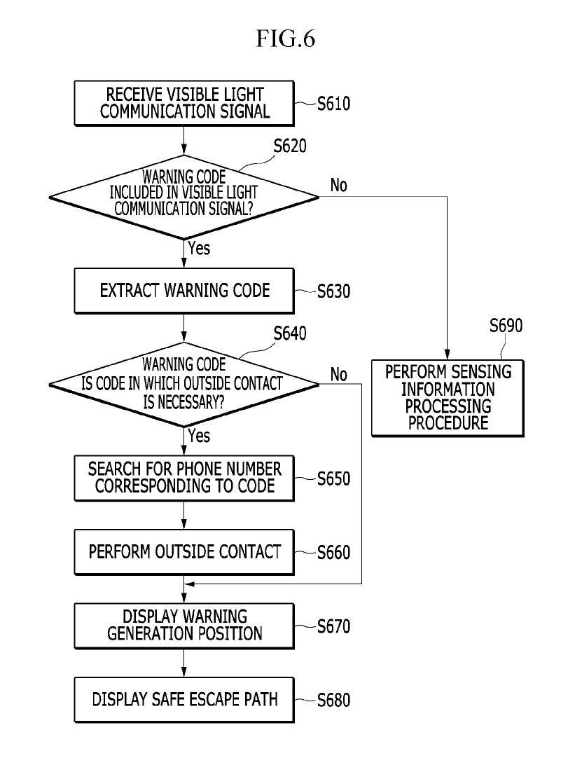

FIG. 6 is a flowchart showing a method of processing warning in the visible light receiving terminal 140 according to an embodiment of the present invention.

Referring to FIG. 6, the visible light receiving terminal 140 receives a visible light communication signal from the LED lightings 112 (S610). The visible light receiving terminal 140 determines whether the visible light communication signal includes a warning code (S620). When the visible light communication signal includes the warning code, the visible light receiving terminal 140 performs a normal visible light communication signal processing procedure (S690). When the visible light communication signal includes the warning code, the visible light receiving terminal 140 extracts the warning code from the visible light communication signal (S630).

The visible light receiving terminal 140 determines whether the extracted warning code is a code in which an outside contact is necessary (S640). If the extracted warning code is the code in which the outside contact is necessary, the visible light receiving terminal 140 searches for phone numbers corresponding to codes and determines a phone number corresponding to the extracted warning code (S650). The visible light receiving terminal 140 performs the outside contact using a communication means based on the phone number (S660). In this case, when performing the outside contact, the visible light receiving terminal 140 may provide a warning name that indicates the warning code and an ID of the LED lighting 112 that is presently positioned.

When the outside contact is terminated or the extracted warning code is the code in which the outside contact is unnecessary at step S640, the visible light receiving terminal 140 displays a warning generation position based on lighting distribution information that is included in the visible light communication signal that is received in the LED lighting 112 (S670). In this case, the visible light receiving terminal 140 may display a region map based on the lighting distribution information. The visible light receiving terminal 140 displays an escape path in the terminal (S680).

According to an embodiment of the present invention, a warning generating position and an escape guide position, which is dynamically generated in connection with the warning generating position, can be directionally indicated by LED lightings regardless of a user's position. As a result, in case of emergency, information transmission effect can be maximized.

Further, in addition to directional information that is displayed by lighting, position information of an entire path, the warning generating position, and a selected safe escape position can be displayed in a visible light receiving terminal, and a contact to the outside can be performed by the visible light receiving terminal.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A lighting indication device connected to a plurality of LED sensing lightings via a lighting network, the device comprising:
a receiver configured to receive sensing information from at least one of the plurality of LED sensing lightings via the lighting network and determine whether the sensing information includes a warning code;
a warning position identifier configured to identify a position of an LED sensing lighting in which warning occurs based on the sensing information when the sensing information includes the warning code;
a path setting unit configured to generate a warning lighting signal for indicating warning generation information and an escape guide lighting signal for indicating an escape guide path based on the position of the LED sensing lighting in which the warning occurs; and
a transmitter configured to transmit the warning lighting signal and the escape guide lighting signal to the plurality of LED sensing lightings via the lighting network.

2. The device of claim 1, wherein each LED sensing lighting includes a sensor configured to generate the sensing information and LED lighting configured to flicker according to the warning lighting signal and the escape guide lighting signal.

3. The device of claim 2, wherein the receiver extracts an identifier of a sensor in which the warning occurs from the sensing information, and
the path setting unit determines a position of the sensor in which the warning occurs based on the identifier.

4. The device of claim 3, further comprising a lighting distribution storage configured to store lighting distribution information about a distribution state of the plurality of LED sensing lightings.

5. The device of claim 4, wherein the path setting unit searches for the path generating information and the escape guide path based on the position of the sensor and the lighting distribution information of the lighting distribution storage.

6. The device of claim 4, wherein the warning lighting signal includes the lighting distribution information.

7. The device of claim 2, wherein the warning lighting signal and the escape guide lighting signal each includes information for controlling a flickering speed of the LED lighting.

8. The device of claim 2, wherein the warning lighting signal and the escape guide lighting signal each includes information for controlling a flickering color of the LED lighting.

9. The device of claim 1, wherein the warning generation information includes a direction where the warning occurs.

10. The device of claim 9, wherein the warning generation information further includes a position where the warning occurs.

11. The device of claim 1, further comprising an outside warning receiver configured to receive warning data from an outside path.

12. A method of indicating lighting of a lighting indication device connected to a plurality of LED sensing lightings via a lighting network, the method comprising:
receiving sensing information;
identifying a warning generation position based on the sensing information when the sensing information includes a warning code;
generating a warning lighting signal for indicating warning generation information and an escape guide lighting signal for indicating an escape guide direction, based on the warning generation position; and
transmitting the warning lighting signal and the escape guide lighting signal to the plurality of LED sensing lightings via the lighting network.

13. The method of claim 12, wherein the warning generation information includes a warning generation direction.

14. The method of claim 12, wherein receiving the sensing information includes receiving the sensing information that is detected in at least one of the plurality of LED sensing lightings.

15. The method of claim 14, wherein identifying the warning generation position includes identifying the warning generation position based on an identifier of the at least one LED sensing lighting.

16. The method of claim 12, further comprising generating the warning generation information and the escape guide direction based on the warning generation position and a database that stores lighting distribution information about a distribution state of the plurality of LED sensing lightings.

17. The method of claim 12, wherein the warning lighting signal and the escape guide lighting signal each includes information for controlling at least one of a flickering speed and a flickering color of the LED sensing lighting.

18. A method of processing warning in a visible light receiving terminal connected to a plurality of LED sensing lightings via visible light communication, the method comprising:
receiving a visible light communication signal from at least one of the plurality of LED sensing lightings;
extracting a warning code from the visible light communication signal;
determining whether an outside contact is necessary based on the warning code;
displaying a warning generation position based on the visible light communication signal when the outside contact is terminated or is unnecessary; and
displaying an escape path.

19. The method of claim 18, wherein the visible light communication signal includes lighting distribution information of the plurality of LED sensing lightings, and
displaying the warning generation position includes displaying the warning generation position based on the lighting distribution information.

20. The method of claim 18, further comprising searching for a phone number for the outside contact based on the warning code when the outside contact is necessary.
